(19) United States
(12) Patent Application Publication
(10) Pub. No.: US 2015/0227327 A1
(43) Pub. Date: Aug. 13, 2015

(54) NETWORK SYSTEM, INFORMATION PROCESSING APPARATUS, AND PRINT SETTING METHOD

(71) Applicant: Chiaki AKIYAMA, Kanagawa (JP)

(72) Inventor: Chiaki AKIYAMA, Kanagawa (JP)

(21) Appl. No.: 14/592,319

(22) Filed: Jan. 8, 2015

(30) Foreign Application Priority Data
Feb. 7, 2014 (JP) 2014-022611

(51) Int. Cl. G06F 3/12; H04N 1/00

(52) U.S. Cl. CPC G06F 3/1219; H04N 1/00482; G06F 3/1254; H04N 1/00204; G06F 3/1293; G06F 3/1296; H04N 2201/0094

(57) ABSTRACT

A network system includes an information processing apparatus that transmits a target value of an achievement objective to contribute to at least one of environment and reduction in total cost of ownership, an acquiring unit that acquires the target value from the information processing apparatus via a network, a storage unit that stores therein correspondence information indicating a correspondence relation between a plurality of different print settings and achievement expected values of the achievement objective expected when the respective print settings are applied to printing, an extracting unit that extracts one or more print settings, in each of which the achievement expected value meets the target value, based on the correspondence information, and a display unit that displays setting information indicating the one or more print settings extracted by the extracting unit.

### CROSS-REFERENCE TO RELATED APPLICATIONS

The present application claims priority to and incorporates by reference the entire contents of Japanese Patent Application No. 2014-022611 filed in Japan on Feb. 7, 2014.

### BACKGROUND OF THE INVENTION

1. Field of the Invention

The present invention relates to a network system, an information processing apparatus, and a print setting method.

2. Description of the Related Art

When printing documents via a personal computer (PC), it is common to display, as a preview, the end result of printing on a screen of the PC and confirm or change print settings. It is well known that when a print setting, such as duplex printing or combined printing, for saving the number of output sheets is made, a sheet usage reduction ratio is displayed on the screen to encourage saving of sheets in order to encourage a print setting effective for environment or reduction in total cost of ownership (TOC). Further, there is a need to allow an administrator of a network system to determine settings of applications on a client and distribute the settings from a server to the client.

Japanese Patent No. 3943829 describes a print condition setting apparatus capable of easily setting print conditions when printing image data.

However, conventionally, the administrator is not allowed to perform setting on applications on a client via a network with regard to contribution to the environment or reduction in the total cost of ownership.

The present invention has been conceived in view of the above, and there is a need for a network system, an information processing apparatus, and a print setting method that enable an administrator to perform print setting on a client terminal of a user via a network so as to meet a target value of an achievement objective, which is to contribute to at least one of environment and reduction in the total cost of ownership, as desired by the administrator.

### SUMMARY OF THE INVENTION

It is an object of the present invention to at least partially solve the problems in the conventional technology.

There is provided a network system that includes an information processing apparatus that transmits a target value of an achievement objective to contribute to at least one of environment and reduction in total cost of ownership; an acquiring unit that acquires the target value from the information processing apparatus via a network; a storage unit that stores therein correspondence information indicating a correspondence relation between a plurality of different print settings and achievement expected values of the achievement objective expected when the respective print settings are applied to printing; an extracting unit that extracts one or more print settings, in each of which the achievement expected value meets the target value, based on the correspondence information; and a display unit that displays setting information indicating the one or more print settings extracted by the extracting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram illustrating a configuration example of an image forming system;

FIG. 2 is a block diagram illustrating an overview of a program and the like in a client terminal;

FIG. 3 is a block diagram illustrating a configuration of a plug-in;

FIG. 4 is a block diagram illustrating configurations of a plug-in and peripherals;

FIGS. 5A and 5B are a diagram and a table illustrating operation performed by the client terminal to acquire a setting of a plug-in from an application server;

FIG. 6 is a diagram illustrating an example of a screen in which a setting of a plug-in is set by an administrator;

FIG. 7 is a table illustrating setting items for the plug-in and access rights with respect to values of the setting items;

FIG. 8 is a flowchart illustrating operation performed by the client terminal when a user causes an output device to perform printing by using the client terminal;

FIG. 9 is a diagram illustrating an overview of a network system;

FIG. 10 is a functional block diagram illustrating an overview of functions of a user PC;

FIG. 11 is a functional block diagram illustrating an overview of functions of an administrator PC;

FIG. 12 is a table illustrating a configuration of a management status stored in a management status DB;

FIG. 13 is a diagram illustrating an overview of operation of the network system;

FIG. 14 is a table illustrating a configuration of distribution information transmitted by the administrator PC;

FIG. 15 is a table illustrating contents of a setting contained in the distribution information illustrated in FIG. 14;

FIG. 16 is a flowchart illustrating operation of the user PC;

FIG. 17 is a flowchart illustrating installation operation performed by the user PC;

FIG. 18 is a flowchart illustrating operation of the administrator PC;

FIG. 19 is a flowchart illustrating operation performed by the user PC when the user PC sends a request for a plug-in body to a software management PC;

FIG. 20 is a flowchart illustrating operation performed by the user PC when the software management PC transmits the plug-in body to the user PC in response to an instruction from the administrator PC;

FIG. 21 is a functional block diagram illustrating an example of functions of the plug-in;

FIG. 22 is a flowchart illustrating an example of operation of the client terminal;

FIG. 23 is a diagram illustrating an example of a print dialog displayed by the client terminal;

FIG. 24 is a table illustrating an example of a correspondence table (correspondence information); and

FIG. 25 is a diagram illustrating the print dialog displayed when the client terminal sets a print setting that meets a target value of an achievement objective desired by the administrator.

### DETAILED DESCRIPTION OF THE PREFERRED EMBODIMENTS

### Embodiment

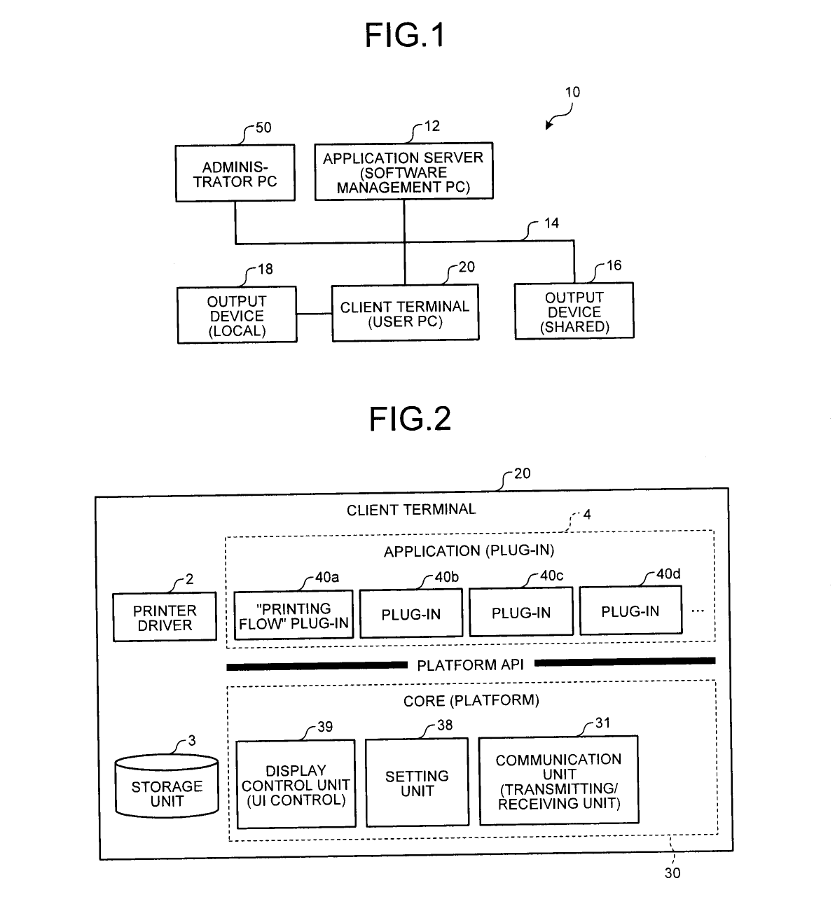

Exemplary embodiments of an image forming system (network system) will be described in detail below with reference to the accompanying drawings. FIG. 1 is a configuration diagram illustrating a configuration example of an image forming system 10. As illustrated in FIG. 1, the image forming system 10 is a client-server system, in which an application server (software management PC) 12 is connected to an output device (shared) 16, an administrator PC 50, and a client terminal (user PC) 20 via a network 14 in a wired or wireless manner. An output device (local) 18 is connected to the client terminal 20.

Each of the application server 12, the client terminal 20, and the administrator PC 50 is a computer (information processing apparatus) that operates by executing a computer program, and includes an input/output device, such as a keyboard and display or a touch panel. The administrator PC 50 is used by an administrator to perform setting on the client terminal 20 of a user. The application server 12 stores therein software (a platform, a plug-in body, setting data, and the like) to be distributed to the client terminal 20. The administrator PC 50 and the application server 12 may be integrated with each other.

The client terminal 20 is a terminal used by a user. The output device 16 is an image forming apparatus, such as a multifunction peripheral, that implements various functions according to settings. The output device 16 is available to (shared by) a plurality of the client terminals 20. The output device 18 is, for example, an image forming apparatus or the like that is locally connected to one of the client terminals 20 via wired or wireless communication.

The image forming system 10 does not necessarily have to be configured as described above, and may include a plurality of the application servers 12, the client terminals 20, and the output devices 16, for example.

Next, the client terminal 20 will be described in detail. FIG. 2 is a block diagram illustrating an overview of a program and the like in the client terminal 20. As illustrated in FIG. 2, the client terminal 20 includes a platform 30 as a core, an application 4 that operates on the platform 30 via a platform API, and a printer driver 2. The platform 30, the application 4, the printer driver 2, and the like may be stored in a storage unit 3.

The platform 30 includes, for example, a communication unit (transmitting/receiving unit) 31, a setting unit 38, and a display control unit (user interface (UI) control) 39. The communication unit 31 transmits and receives data to and from the application server 12 serving as a web server. The setting unit 38 stores therein settings on each of plug-ins 40a, 40b, 40c, and 40d of the application 4 and applies the settings. The display control unit 39 controls a user interface (performs UI control) to change settings by receiving input operation of changing the settings on the client terminal 20 from a user, and displays (outputs) a setting screen or the like for indicating the settings.

The application 4 includes, for example, the plug-ins 40a, 40b, 40c, and 40d. The plug-ins 40a, 40b, 40c, and 40d use functions and settings on the platform 30. Here, it is assumed that the plug-in 40a is a “printing flow” plug-in that executes a printing flow on the output device 16. The printer driver 2 includes a driver platform or the like for outputting print data to the output device 16.

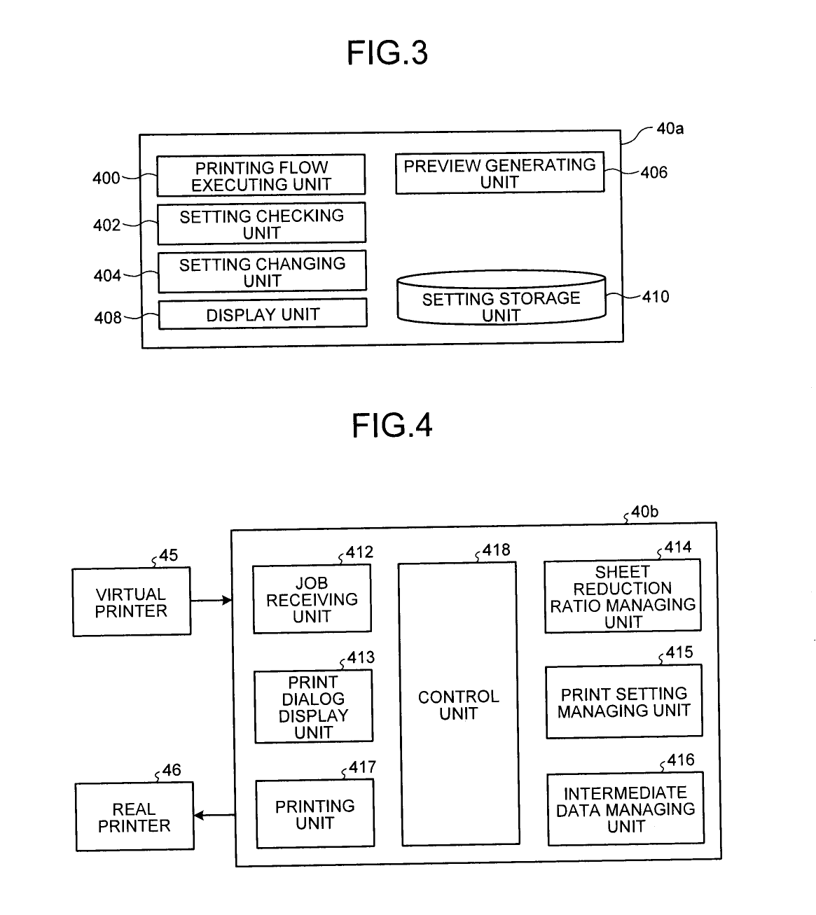

FIG. 3 is a block diagram illustrating a configuration of the plug-in 40a. As illustrated in FIG. 3, the plug-in 40a includes, for example, a printing flow executing unit 400, a setting checking unit 402, a setting changing unit 404, a preview generating unit 406, a display unit 408, and a setting storage unit 410.

The printing flow executing unit 400 controls execution of a printing flow. The setting checking unit 402 confirms (checks) settings on print data. The setting changing unit 404 changes the settings on the print data. The preview generating unit 406 generates a print preview image by using the print data and information on a print setting. The display unit 408 displays print setting items, the print preview image, and the like on a screen. The setting storage unit 410 stores therein the print setting or the like set by an administrator or a user.

FIG. 4 is a block diagram illustrating configurations of the plug-in 40b and peripherals thereof. A virtual printer 45 converts drawing data obtained from a printing application (not illustrated) to image data (for example, EMF, Bitmap, XPS, or the like) independent from the printer driver, and stores the image data as a file in a storage device (not illustrated) in the client terminal 20. The virtual printer 45 also stores therein, for example, information indicating a print setting of the output device 16, together with the image data.

The plug-in 40b includes a job receiving unit 412, a print dialog display unit 413, a sheet reduction ratio managing unit 414, a print setting managing unit 415, an intermediate data managing unit 416, a printing unit 417, and a control unit 418.

The job receiving unit 412 communicates with the virtual printer 45 and receives a job event, such as a job start and a job end, and intermediate data generated by the virtual printer 45.

The control unit 418 controls job processing performed by the plug-in 40b, and sends a job received from the job receiving unit 412 to the print dialog display unit 413 and the printing unit 417.

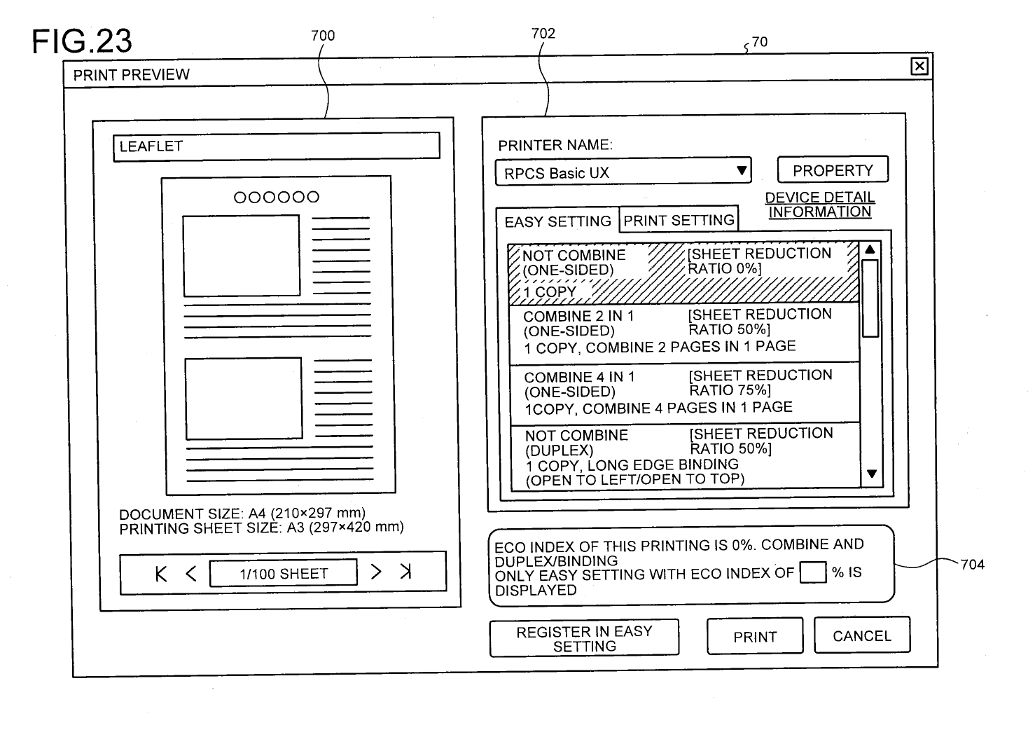

The print dialog display unit 413 displays a print dialog (see FIG. 23) to be described later. The sheet reduction ratio managing unit 414 calculates and stores therein a sheet reduction ratio according to a print setting to be described later. The print setting managing unit 415 performs a process of storing or changing the print setting, for example. The intermediate data managing unit 416 stores therein intermediate data or the like.

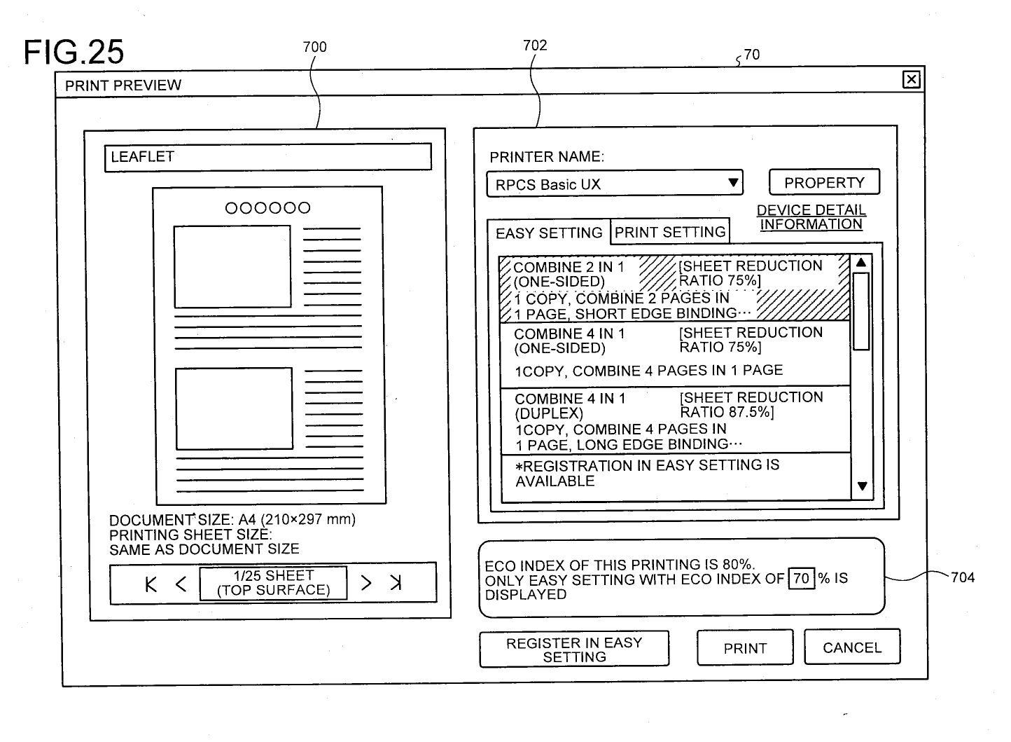

The printing unit 417 outputs a request to print intermediate data to a real printer 46. The printing unit 417 applies a print setting set on the print dialog (see FIG. 25).

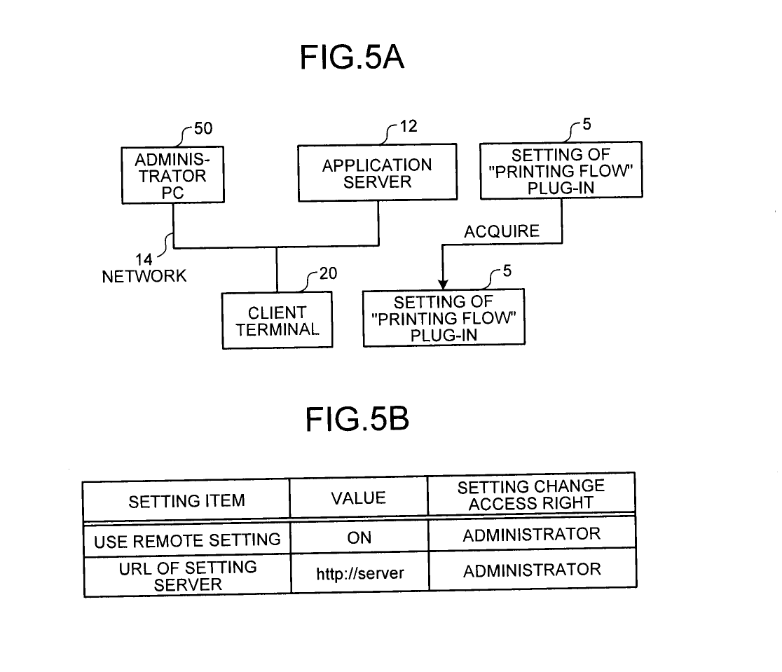

Next, operation performed by the client terminal 20 to acquire a setting of a plug-in from the application server 12 will be described. FIGS. 5A and 5B are a diagram and a table illustrating the operation performed by the client terminal to acquire the setting of the plug-in from the application server 12. As illustrated in FIG. 5A, for example, the client terminal 20 acquires a setting 5 of the “printing flow” plug-in from the application server 12.

FIG. 5B is a table illustrating an example of setting for acquiring the setting 5 of the plug-in. The setting illustrated in FIG. 5B is stored in the setting unit 38 of the platform 30 (FIG. 2). A setting of “use remote setting” is set to cause the client terminal 20 to acquire a setting recommended by an administrator from the application server 12 at the time of start-up, and only an administrator has an access right to change settings. The client terminal 20 acquires the setting 5 of the plug-in from a server written in “URL of setting server”. Each plug-in stores the acquired setting in the setting storage unit 410. The “URL of setting server” may be set differently for each arbitrary group (for example, a department).

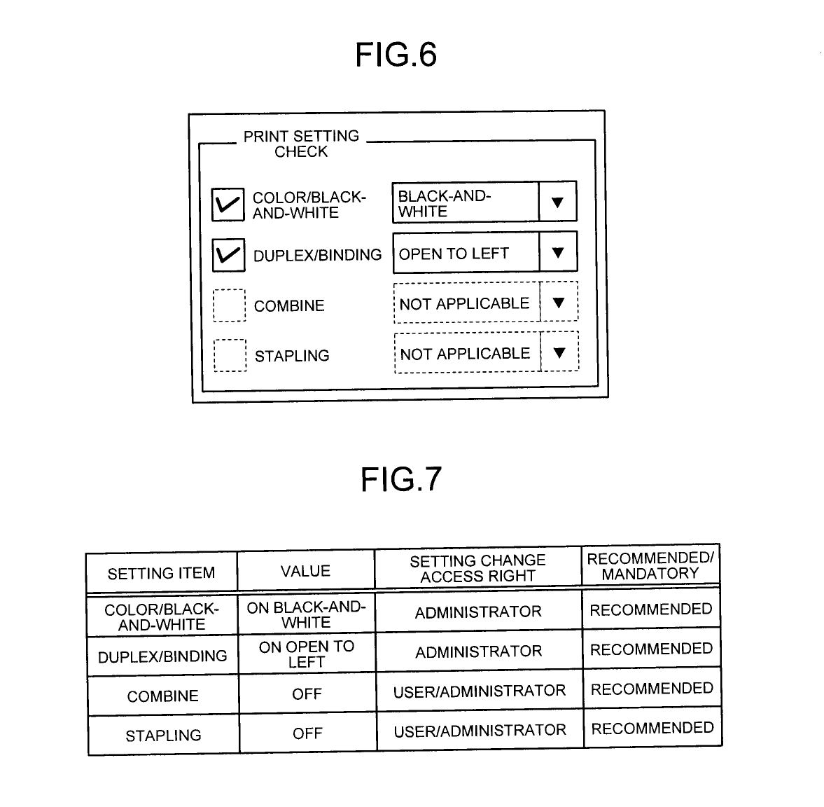

Next, a process performed by an administrator to perform setting on each plug-in will be described. FIG. 6 illustrates an example of a screen in which a setting of the plug-in 40a is set by the administrator. FIG. 7 is a diagram illustrating setting items for the plug-in 40a and access rights with respect to values of the setting items. The administrator sets items, which the administrator recommends to a user in a printing flow and requests the user to check before printing (items to be subjected to a print setting check), and stores the items in the application server 12.

In the example illustrated in FIG. 6, the administrator sets and recommends “black-and-white” printing as default for a setting item of “color/black-and-white”, and requests a user to check the setting before printing. Further, the administrator sets and recommends “open to left” printing as default for a setting item of “duplex/binding”, and requests the user to check the setting before printing. Hereinafter, a print setting check means checking whether a setting recommended by the administrator and a current setting in the client terminal 20 (setting stored in the setting unit 38) match each other. When the setting in the client terminal 20 and the setting recommended by the administrator match each other, it is not necessary to request the user to check the settings before printing.

As illustrated in FIG. 7, only the administrator has access rights to change the settings of values with respect to the setting items of “color/black-and-white” and “duplex/binding”. Namely, as for the setting items of “color/black-and-white” and “duplex/binding”, only the administrator can determine the items as items, which the administrator recommends to the user and requests the user to check before printing.

As for setting items of “combine” and “staple” illustrated in FIG. 6, no settings are recommended as default and the user is not requested to check the settings before printing. Further, as for the setting items of “combine” and “staple”, as illustrated in FIG. 7, both the user and the administrator can set the items as items to be subjected to the print setting check.

As illustrated in FIG. 7, each of the setting items are recommended and set as default by the administrator; however, the setting items may be set as mandatory settings by the administrator.

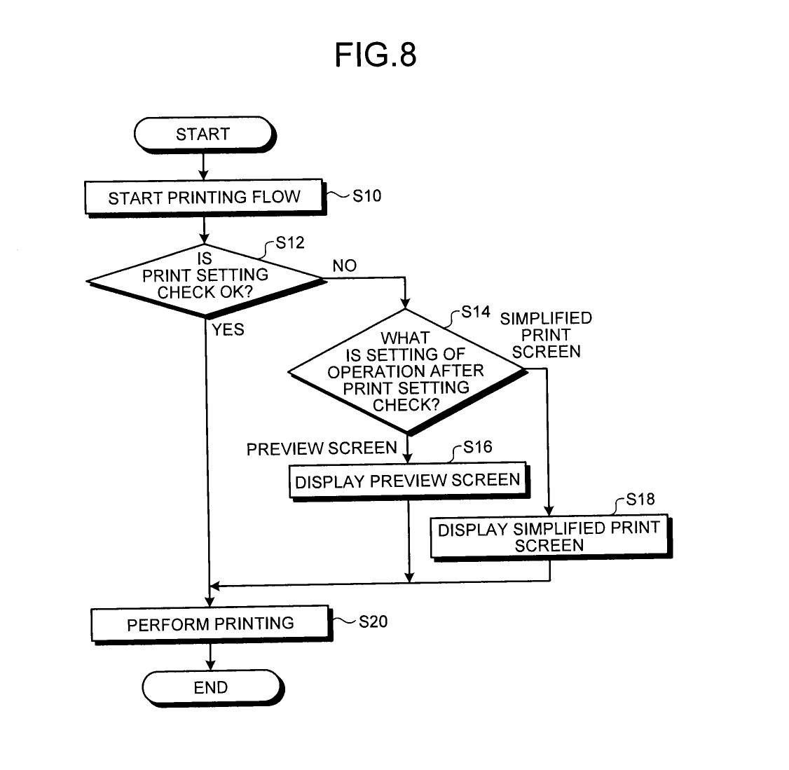

Next, operation performed by the client terminal 20 when the user causes the output device 16 to perform printing by using the client terminal 20 will be described. FIG. 8 is a flowchart illustrating the operation performed by the client terminal 20 when the user causes the output device 16 to perform printing by using the client terminal 20.

At Step S10, the client terminal 20 starts a printing flow in response to an instruction to start printing, which is input by the user. Specifically, the printing flow executing unit 400 starts the printing flow when a printer driver outputs print data.

At Step S12, the client terminal 20 checks (determines) whether a print setting check is OK. Specifically, the setting checking unit 402 of the client terminal 20 determines whether a setting recommended by the administrator and a current setting in the client terminal 20 match each other. When the client terminal 20 determines that the print setting check is OK (settings match) (YES at Step S12), the process proceeds to Step S20. When the client terminal 20 determines that the print setting check is not OK (settings do not match) (NO at Step S12), the process proceeds to Step S14.

Specifically, the setting checking unit 402 performs the print setting check according to contents of the print setting check stored in the setting storage unit 410. For example, in a case where a setting is made to cause the client terminal 20 to check whether black-and-white printing is set, if the current setting in the client terminal 20 is color printing, the process proceeds to Step S14, and if the current setting is black-and-white printing, the process proceeds to Step S20.

At Step S14, the client terminal 20 checks a setting of operation after the print setting check according to the setting. If display of a preview screen is set in the client terminal 20, the process proceeds to Step S16, and if display of a simplified print screen is set, the process proceeds to Step S18.

At Step S16, the client terminal 20 displays the preview screen. Further, the client terminal 20 displays, on the preview screen, “check OK” for a setting item in which the setting recommended by the administrator and the current setting in the client terminal 20 match each other. The client terminal 20 also displays, on the preview screen, “check NG” for a setting item in which the setting recommended by the administrator and the current setting in the client terminal 20 do not match each other. The client terminal 20 allows the user to change the settings of the setting items on the preview screen after the user checks the display of “check OK” or “check NG”.

Specifically, at Step S16, the preview generating unit 406 generates a print preview image, and the display unit 408 displays print setting items and the print preview image. If the user changes a print setting, the setting changing unit 404 changes the print setting.

At Step S18, the client terminal 20 displays the simplified print screen. The client terminal 20 displays, on the simplified print screen, “check OK” for a setting item in which the setting recommended by the administrator and the current setting in the client terminal 20 match each other. The client terminal 20 also displays, on the simplified print screen, “check NG” for a setting item in which the setting recommended by the administrator and the current setting in the client terminal 20 do not match each other. The client terminal 20 allows the user to change the settings of the setting items on the simplified print screen after the user checks the display of “check OK” or “check NG”.

Specifically, at Step S18, the display unit 408 displays print setting items. If the user changes a print setting, the setting changing unit 404 changes the print setting.

At Step S20, the client terminal 20 causes the output device 16 to perform printing. Specifically, the client terminal 20 transfers the print data to the output device 16 according to the print setting. If a setting is changed on the simplified print screen or the preview screen, the client terminal 20 causes the output device 16 to perform printing according to the changed setting.

As described above, the network system (image forming system) 10 can prompt the user to perform setting as recommended by the administrator.

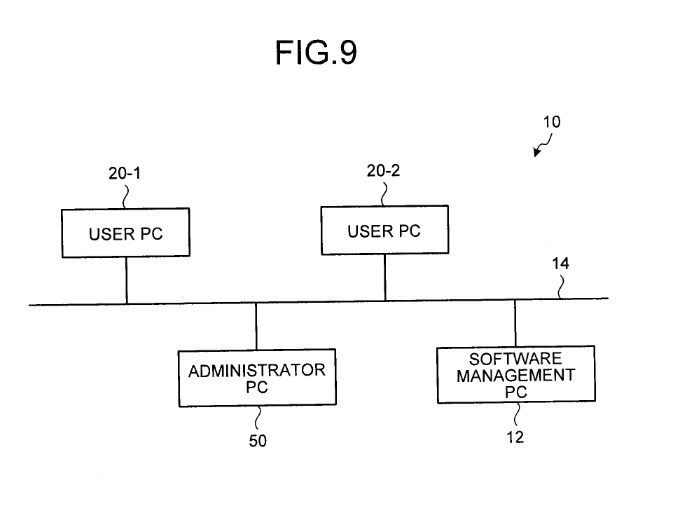

Next, distribution of a setting of a plug-in in the network system 10 will be described in detail. FIG. 9 is a diagram illustrating an overview of the network system (image forming system) 10. As illustrated in FIG. 9, the network system 10 is a client-server system, in which, for example, user personal computers (PCs) 20-1 and 20-2, the administrator PC 50, the software management PC (server) 12 are connected to one another via the network 14. Each of the user PCs (clients) 20-1 and 20-2, the administrator PC 50, and the software management PC 12 is a computer that operates by executing a computer program. The software management PC 12 stores therein software (a plug-in main body) to be distributed to the user PCs 20-1 and 20-2. The administrator PC 50 and the software management PC 12 may be configured to be integrated.

Next, the user PCs 20-1 and 20-2 and the administrator PC 50 will be described in detail. When a plurality of components such as the user PCs 20-1 and 20-2 need not be distinguished from each other, they may be referred to as “the user PC(s) 20”.

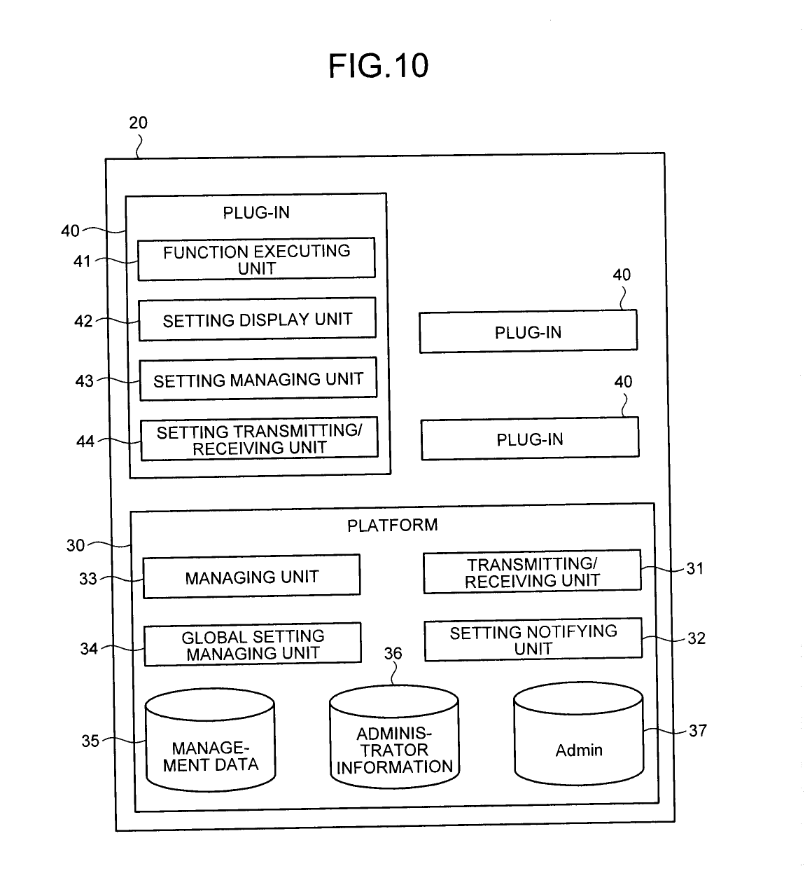

FIG. 10 is a functional block diagram illustrating an overview of functions of the user PC 20. As illustrated in FIG. 10, the user PC 20 includes the platform 30 and a plurality of plug-ins 40 that operate on the platform 30.

The platform 30 includes, for example, the transmitting/receiving unit 31, a setting notifying unit 32, a managing unit 33, a global setting managing unit 34, management data 35, administrator information 36, and an Admin (authority information storage unit) 37.

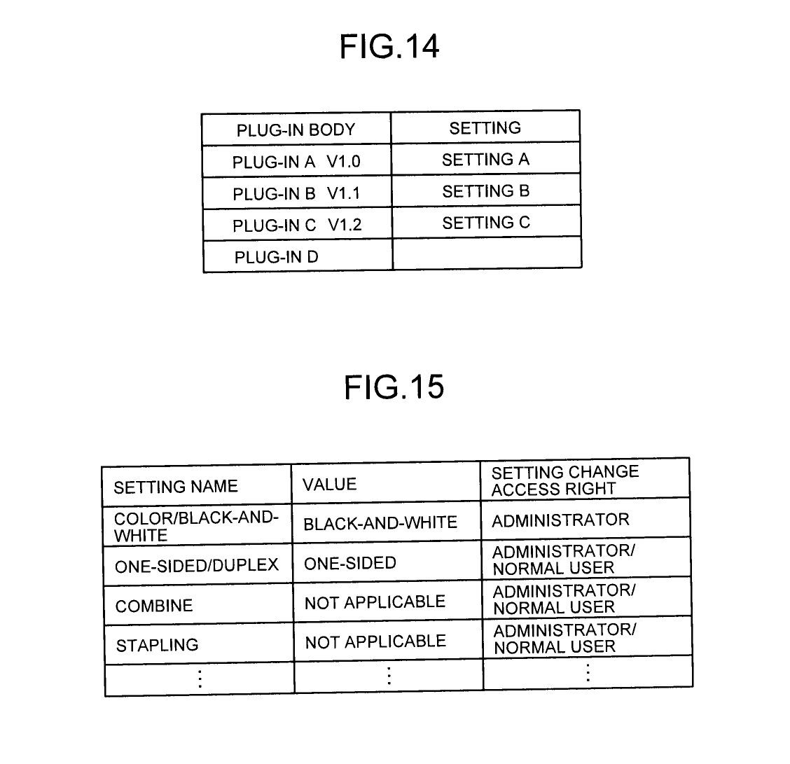

The transmitting/receiving unit 31 includes a transmitting unit and a receiving unit, and performs communication of data, such as a computer program and a setting, via the network 14. The setting notifying unit 32 sends a notification to be described later to the administrator PC 50. The managing unit 33 manages data in the platform 30. The global setting managing unit 34 manages a setting (global setting) corresponding to a function prioritized over a function corresponding to a setting of the plug-ins 40 (to be described later). The management data 35 is a databased used to manage a plurality of the plug-ins 40. The administrator information 36 stores therein administrator information for specifying an administrator serving as a source of distribution of the distribution information, which will be described later with reference to FIG. 14. The Admin 37 is an authority information storage unit that stores therein authority information indicating an administrator right for each of the user PCs 20.

Each of the plug-ins 40 includes a function executing unit 41, a setting display unit 42, a setting managing unit 43, and a setting transmitting/receiving unit 44. The function executing unit 41 executes functions of the plug-in. The setting display unit 42 has a function to display a setting of the plug-in. The setting managing unit 43 manages the setting of the plug-in. The setting transmitting/receiving unit 44 transmits and receives the setting of the plug-in.

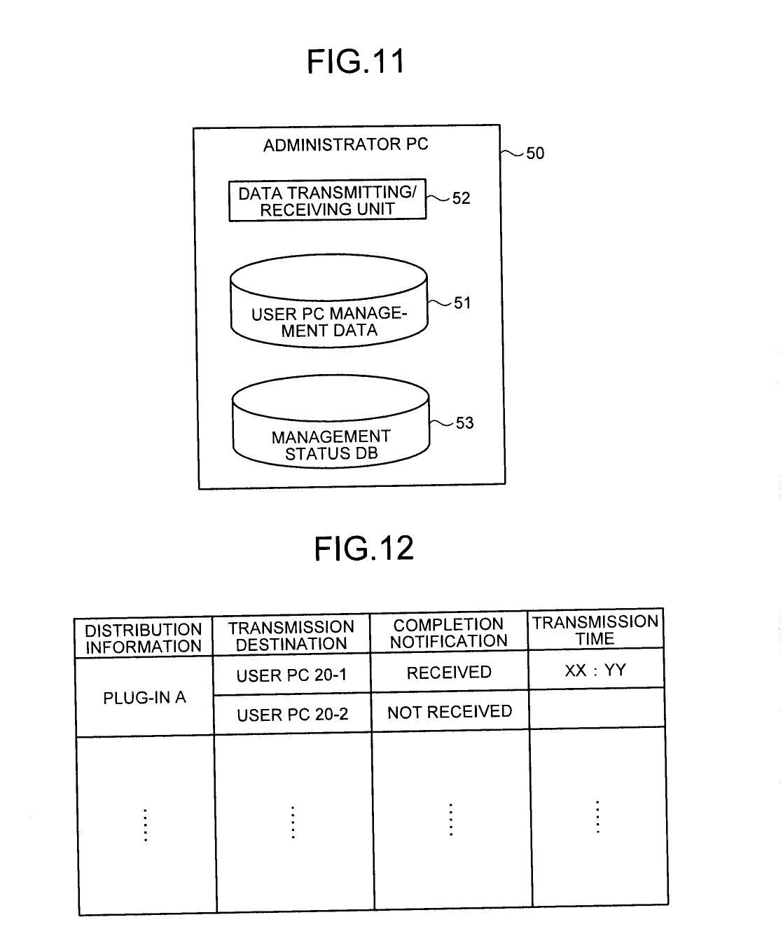

FIG. 11 is a functional block diagram illustrating an overview of functions of the administrator PC 50. As illustrated in FIG. 11, the administrator PC 50 includes user PC management data 51, a data transmitting/receiving unit 52, and a management status database (DB) 53. The user PC management data 51 is management data for managing clients, such as the user PCs 20-1 and 20-2. Management data managed by the user PC management data 51 includes, for example, IP addresses of the user PCs 20-1 and 20-2 and data indicating installed plug-ins. The data transmitting/receiving unit 52 includes a transmitting unit and a receiving unit, and transmits the distribution information to be described later, or the like. The management status DB 53 is a storage unit that stores therein a management status to be described later with reference to FIG. 12.

FIG. 12 is a table illustrating a configuration of the management status stored in the management status DB 53. As illustrated in FIG. 12, the management status includes, for each piece of the distribution information, a destination to transmit the distribution information, a status indicating reception or non-reception of a notification as to whether installation of software corresponding to the distribution information is completed, a transmission time at which the received notification is transmitted, and the like.

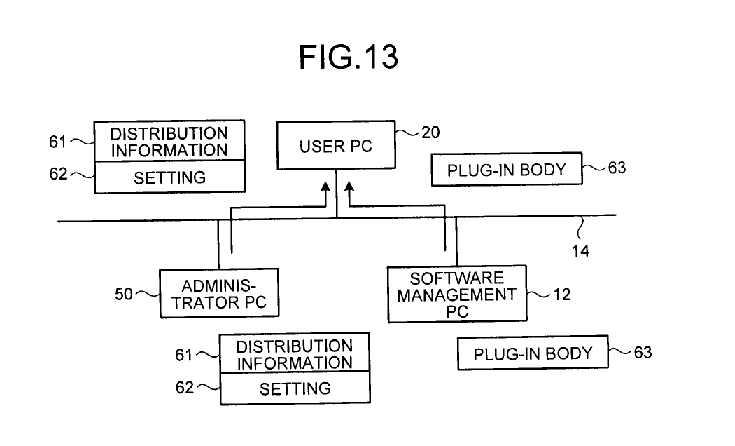

Next, an overview of operation of the network system 10 will be described. FIG. 13 is a diagram illustrating an overview of the operation of the network system 10. As illustrated in FIG. 13, the administrator PC 50 transmits distribution information 61 to the user PC 20 via the network 14. The distribution information 61 contains a setting 62 (to be described later with reference to FIG. 15, for example). The software management PC 12 transmits a plug-in body 63 to the user PC 20 via the network 14 in response to a request from the user PC 20, for example. The software management PC 12 may be configured to transmit the plug-in body 63 to the user PC 20 in response to an instruction from the administrator PC 50. The distribution information 61 contains, in the header (not illustrated) for example, administrator information for specifying an administrator serving as a source of distribution of the distribution information 61.

FIG. 14 is a table illustrating a configuration of the distribution information 61 transmitted by the administrator PC 50. As illustrated in FIG. 14, the distribution information 61 contains information for specifying plug-in main bodies, and settings (for example, settings A to C) corresponding to the respective plug-in main bodies. The distribution information 61 may contain software, such as a plug-in D, for which no setting is made.

FIG. 15 is a table illustrating contents of a setting (for example, the setting A) contained in the distribution information 61 illustrated in FIG. 14. As illustrated in FIG. 15, the contents of a setting include setting names indicating names of functions that vary depending on settings, values (setting values), and setting change access rights that are attributes indicating whether to permit a change in the settings (values). For example, only the administrator (only through the administrator PC 50) can change a value of a setting for which the setting change access right is set to “administrator”. Further, both the administrator and a general user (through the administrator PC 50 and the user PCs 20-1 and 20-2) can change a value of a setting for which the setting change access right is set to “administrator/general user”.

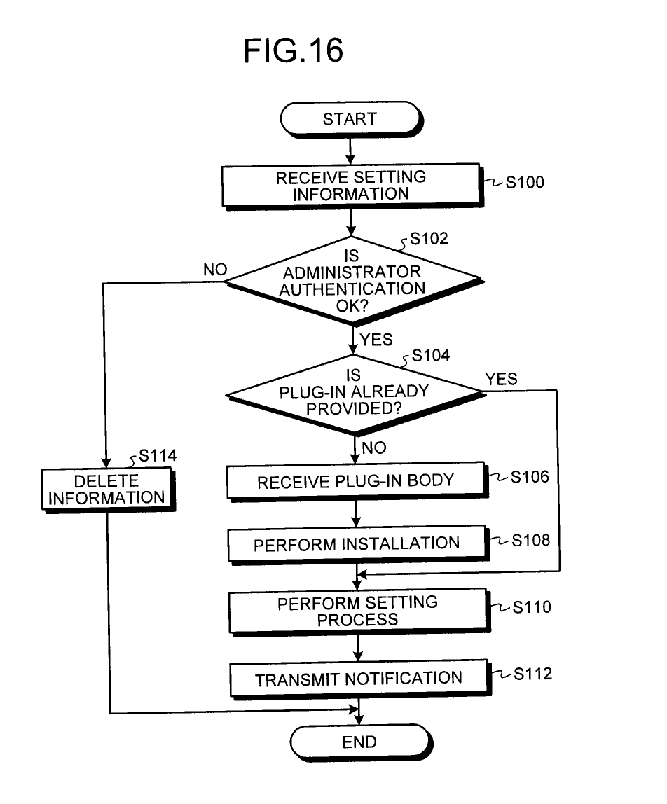

Next, operation of the network system 10 will be described. FIG. 16 is a flowchart illustrating the operation of the user PC 20. As illustrated in FIG. 16, at Step S100, the user PC 20 receives the distribution information (see FIGS. 14 and 15) from the administrator PC 50. Specifically, the user PC 20 receives the contents of the setting (setting information) illustrated in FIG. 15.

At Step S102, the user PC 20 performs administrator authentication by referring to the administrator information included in, for example, the header of the distribution information illustrated in FIG. 14 to determine whether the distribution information is normal. When the user PC 20 has successfully completed the administrator authentication (YES at Step S102), the process proceeds to Step S104. When the administrator authentication is not successfully completed (NO at Step S102), the process proceeds to Step S114.

At Step S104, the user PC 20 determines whether a plug-in indicated by the distribution information is already provided. When the user PC 20 is not provided with the plug-in (NO at Step S104), the process proceeds to Step S106. When the user PC 20 is already provided with the plug-in (YES at Step S104), the process proceeds to Step S110.

At Step S106, the user PC 20 receives the plug-in body.

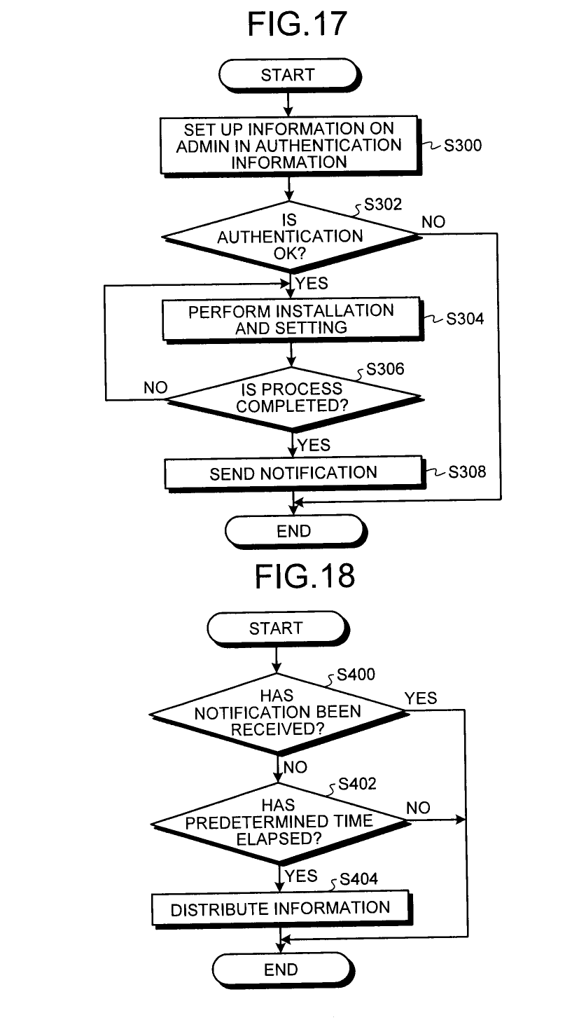

At Step S108, the user PC 20 installs the received plug-in body. Details of installation in the process at Step S108 will be described later with reference to FIG. 17.

At Step S110, the user PC 20 performs a setting process on the installed plug-in body by using the setting contained in the distribution information.

At Step S112, the user PC 20 transmits a notification indicating completion of the setting to the administrator PC 50.

At Step S114, the user PC 20 deletes the received distribution information.

Next, installation operation (Step S108 in FIG. 16) performed by the user PC 20 will be described in detail. FIG. 17 is a flowchart illustrating the installation operation performed by the user PC 20. As illustrated in FIG. 17, at Step S300, the user PC 20 sets up information on the Admin in authentication information. Specifically, the user PC 20 reads, from the Admin 37 (FIG. 10), authority information indicating an administrator right for the user PC 20, and displays a screen to ask approval of a user for which the authority information is input in advance.

At Step S302, the user PC 20 determines whether the administrator right is successfully authenticated. For example, when the user PC 20 receives input indicating that the administrator right is successfully authenticated (YES at Step S302), the process proceeds to Step S304. When the administrator right is not successfully authenticated (NO at Step S302), the process ends.

At Step S304, the user PC 20 performs a process, such as specific installation and setting.

At Step S306, the user PC 20 determines whether the process at Step S304 is completed. When the user PC 20 determines that the process at Step S304 is not completed (NO at Step S306), the process at Step S304 is continued. When the user PC 20 determines that the process at Step S304 is completed (YES at Step S306), the process proceeds to Step S308.

At Step S308, the user PC 20 sends a notification indicating completion of the process, such as specific installation and setting, to the administrator PC 50.

FIG. 18 is a flowchart illustrating operation of the administrator PC 50. As illustrated in FIG. 18, at Step S400, the administrator PC 50 determines whether the administrator PC 50 has received the notification sent by the user PC 20 in the process at Step S308 illustrated in FIG. 17. When the administrator PC 50 determines that the notification has not been received (NO at Step S400), the process proceeds to Step S402. When the administrator PC 50 determines that the notification has been received (YES at Step S400), the process ends.

At Step S402, the administrator PC 50 determines whether a predetermined time has elapsed. When the administrator PC 50 determines that the predetermined time has elapsed (YES at Step S402), the administrator PC 50 determines that the setting or the like in the user PC 20 is processed properly, and the process proceeds to Step S404. When the administrator PC 50 determines that the predetermined time has not elapsed (NO at Step S402), the process ends.

At Step S404, the administrator PC 50 distributes (redistributes) the distribution information. The administrator PC 50 performs the processes from Step S400 to Step S404 at predetermined timings, and redistributes the distribution information to the user PC 20 for which installation or setting is not completed after a lapse of the predetermined time, so that it is possible to prompt the user to perform installation or setting operation.

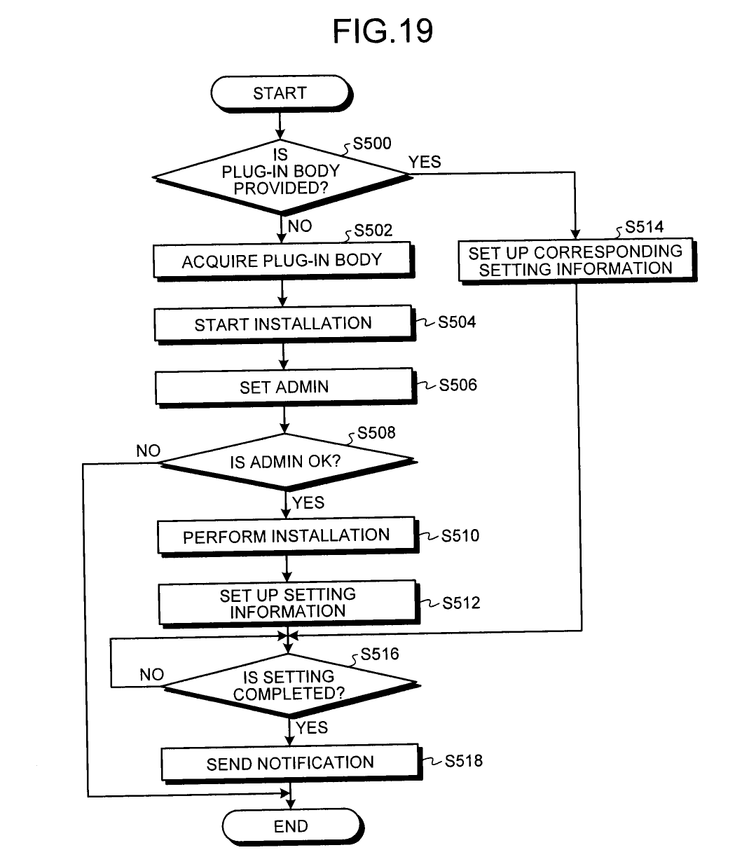

Next, operation performed by the user PC 20 when the user PC 20 sends a request for a plug-in body to the software management PC 12 will be described. FIG. 19 is a flowchart illustrating the operation performed by the user PC 20 when the user PC 20 sends a request for a plug-in body to the software management PC 12. As illustrated in FIG. 19, at Step S500, the user PC 20 determines whether a plug-in body indicated by the distribution information is already provided. When the user PC 20 is not provided with the plug-in body (NO at Step S500), the process proceeds to Step S502. When the user PC 20 is already provided with the plug-in body (YES at Step S500), the process proceeds to Step S514.

At Step S502, the user PC 20 acquires the plug-in body.

At Step S504, the user PC 20 starts installation (starts operation of an installer).

At Step S506, the user PC 20 sets up information on the Admin in authentication information. Specifically, the user PC 20 reads, from the Admin 37 (FIG. 10), authority information indicating an administrator right for the user PC 20, and displays a screen to ask approval of a user for which the authority information is input in advance.

At Step S508, the user PC 20 determines whether the administrator right is successfully authenticated. For example, when the user PC 20 receives input indicating that the administrator right is successfully authenticated (YES at Step S508), the process proceeds to Step S510. When the administrator right is not successfully authenticated (NO at Step S508), the process ends.

At Step S510, the user PC 20 installs the plug-in body.

At Step S512, the user PC 20 sets up, for the plug-in body, the contents of the setting (setting information) as illustrated in FIG. 15.

At Step S514, the user PC 20 sets up contents of a setting (setting information) corresponding to the plug-in body that is already provided to the user PC 20.

At Step S516, the user PC 20 determines whether the setting is completed. When the user PC 20 determines that the setting is not completed (NO at Step S516), the process is continued until the setting is completed. When the user PC 20 determines that the setting is completed (YES at Step S516), the process proceeds to Step S518.

At Step S518, the user PC 20 sends a notification indicating completion of the setting to the administrator PC 50.

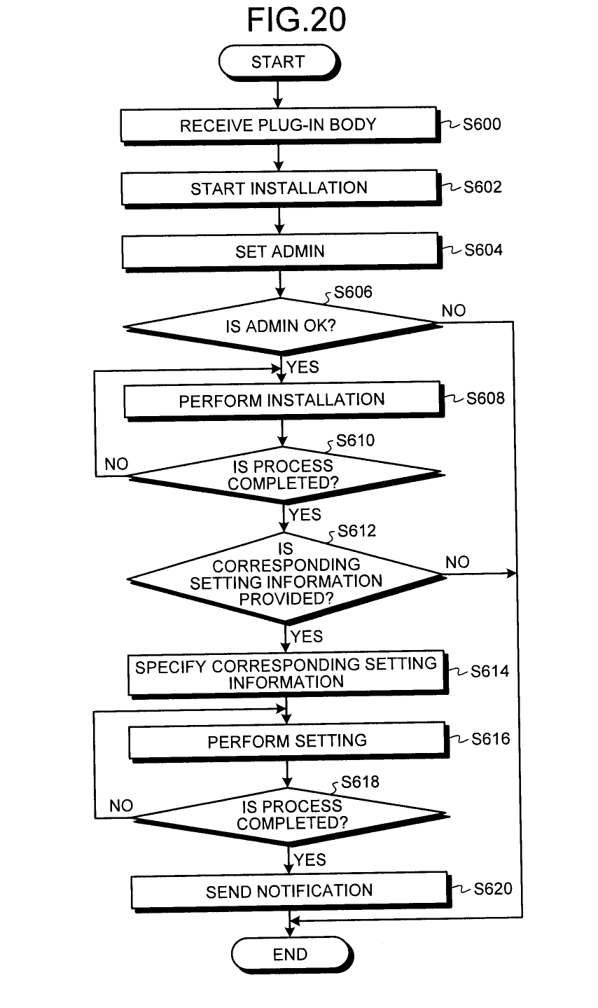

Next, operation performed by the user PC 20 when the software management PC 12 transmits a plug-in body to the user PC 20 in response to an instruction from the administrator PC 50 will be described. FIG. 20 is a flowchart illustrating the operation performed by the user PC 20 when the software management PC 12 transmits a plug-in body to the user PC 20 in response to an instruction from the administrator PC 50. As illustrated in FIG. 20, at Step S600, the user PC 20 receives a plug-in body transmitted by the administrator PC 50.

At Step S602, the user PC 20 starts installation (starts operation of an installer).

At Step S604, the user PC 20 sets up information on the Admin in the authentication information. Specifically, the user PC 20 reads, from the Admin 37 (FIG. 10), authority information indicating an administrator right for the user PC 20, and displays a screen to ask approval of a user for which the authority information is input in advance.

At Step S606, the user PC 20 determines whether the administrator right is successfully authenticated. For example, when the user PC 20 receives input indicating that the administrator right is successfully authenticated (YES at Step S606), the process proceeds to Step S608. When the administrator right is not successfully authenticated (NO at Step S606), the process ends.

At Step S608, the user PC 20 installs the plug-in body.

At Step S610, the user PC 20 determines whether the process at Step S608 is completed. When the user PC 20 determines that the process at Step S608 is not completed (NO at Step S610), the process at Step S608 is continued. When the user PC 20 determines that the process at Step S608 is completed (YES at Step S610), the process proceeds to Step S612.

At Step S612, the user PC 20 determines whether the contents of the setting (setting information) corresponding to the installed plug-in body are provided as illustrated in FIG. 15. When the user PC 20 determines that the corresponding setting information is provided (YES at Step S612), the process proceeds to Step S614. When the user PC 20 determines that the corresponding setting information is not provided (NO at Step S612), the process ends.

At Step S614, the user PC 20 specifies a piece of setting information corresponding to the installed plug-in body from among a plurality of pieces of setting information.

At Step S616, the user PC 20 sets up the piece of the setting information specified in the process at Step S614 in the plug-in body.

At Step S618, the user PC 20 determines whether the process at Step S616 is completed. When the user PC 20 determines that the process at Step S616 is not completed (NO at Step S618), the process at Step S616 is continued. When the user PC 20 determines that the process at Step S616 is completed (YES at Step S618), the process proceeds to Step S620.

At Step S620, the user PC 20 sends a notification indicating completion of the setting to the administrator PC 50.

If the software management PC 12 transmits a plurality of plug-in bodies to the user PC 20 in response to an instruction from the administrator PC 50, the user PC 20 specifies settings corresponding to the respective plug-in bodies from a plurality of settings, and performs setting for each of the plug-in bodies.

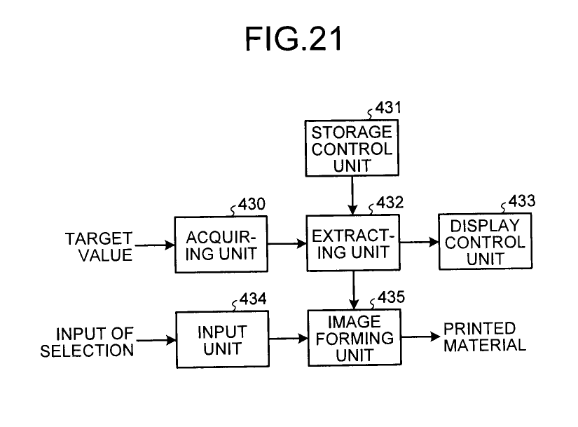

Next, the plug-in 40b will be described in detail. FIG. 21 is a functional block diagram illustrating an example of functions of the plug-in 40b. Each of the functions illustrated in FIG. 21 does not necessarily have to be provided in the client terminal 20, and may be provided in the output device 16 or in the client terminal 20 and the output device 16 in a distributed manner.

An acquiring unit 430 acquires a target value of an achievement objective to contribute to at least one of environment and reduction in total cost of ownership, from the administrator PC 50 via the network, for example. When the acquiring unit 430 has not acquired the target value from the administrator PC 50 or the like via the network, the acquiring unit 430 acquires the target value via an input device in the client terminal 20 or the like. The achievement objective is, for example, an objective to reduce at least one of recording media, such as sheets, used for printing, toner, electricity, and an amount of CO₂ emission due to printing.

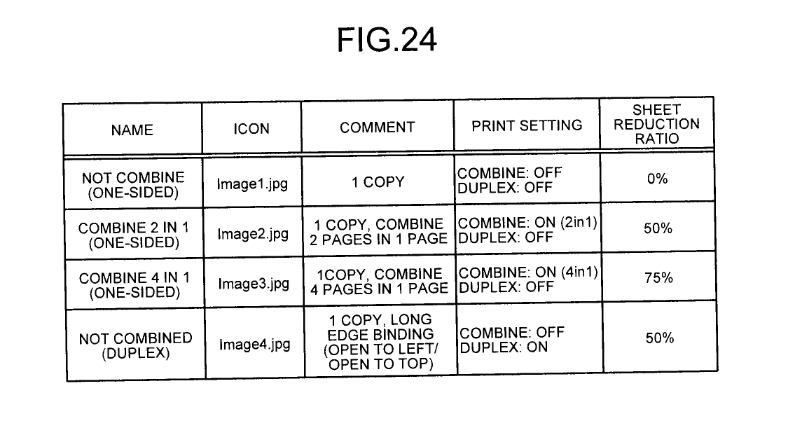

A storage control unit 431 stores, in the storage device (storage unit) in the client terminal 20 for example, correspondence information indicating a correspondence relation between a plurality of different print settings and achievement expected values expected when the respective print settings are applied to printing. Here, the correspondence relation is indicated by a correspondence table (to be described later with reference to FIG. 24) stored in the storage device.

An extracting unit 432 extracts one or more print settings, in each of which the achievement expected value meets the target value, based on the above described correspondence information.

A display control unit 433 displays setting information indicating the one or more print settings extracted by the extracting unit 432 on an output device (display unit) in the client terminal 20 for example.

An input unit 434 receives, from the user, an input of selection of any of the one or more print settings indicated by the setting information displayed by the display control unit 433, from the user via the input device in the client terminal 20 for example.

An image forming unit (printing unit) 435 performs printing based on any of the one or more print settings extracted by the extracting unit 432 in response to the input received by the input unit 434, and outputs a printed material via the output device 16 for example.

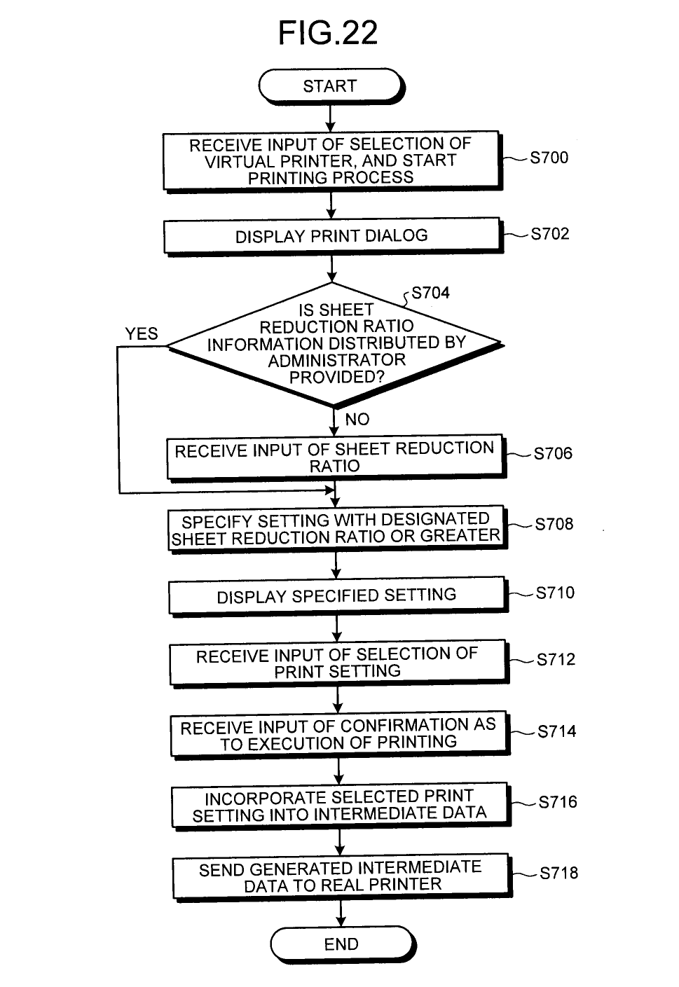

Next, an example of operation of the client terminal 20 will be described. FIG. 22 is a flowchart illustrating an example of the operation of the client terminal 20. As illustrated in FIG. 22, at Step S700, the client terminal 20 receives an input of selection of a virtual printer via the printing application, and starts a printing process.

At Step S702, the client terminal 20 displays a print dialog to be described later with reference to FIG. 23.

At Step S704, the client terminal 20 determines whether information indicating a sheet reduction ratio distributed by the administrator is provided. When the client terminal 20 determines that the information indicating the sheet reduction ratio distributed by the administrator is provided (YES at Step S704), the process proceeds to Step S708. When the client terminal 20 determines that the information indicating the sheet reduction ratio distributed by the administrator is not provided (NO at Step S704), the process proceeds to Step S706.

At Step S706, the client terminal 20 receives an input of a target value of the sheet reduction ratio, as an example of the achievement objective, desired by the user. Here, the acquiring unit 430 acquires the target value.

At Step S708, the client terminal 20 specifies a print setting (setting), in which a sheet reduction ratio equal to or grater than the sheet reduction ratio specified by the administrator (or the user) is expected. The extracting unit 432 extracts a print setting, in which the achievement estimated value meets the target value, based on the above described correspondence information. If a plurality of print settings in which the achievement estimated value meets the target value are present, all of the print settings are displayed in a selectable manner.

At Step S710, the client terminal 20 displays the print setting specified in the process at Step S706 on an output device (display or the like). Here, the display control unit 433 displays the print setting via the output device.

At Step S712, the client terminal 20 receives an input of selection of a print setting from the user. Here, the input unit 434 receives the input of selection from the user.

At Step S714, the client terminal 20 receives an input of confirmation as to execution of printing.

At Step S716, for example, the client terminal 20 causes the image forming unit 435 to incorporate the print setting selected by the user into intermediate data to generate the intermediate data.

At Step S718, the client terminal 20 causes the image forming unit 435 to send the generated intermediate data to the real printer 46, for example.

Next, the print dialog displayed by the client terminal 20 and acquisition of the target value of the achievement objective will be described in detail. FIG. 23 is a diagram illustrating an example of a print dialog 70 displayed by the client terminal 20. The print dialog 70 includes a preview image 700, a print setting UI (print setting input unit) 702, and a sheet reduction ratio setting UI (sheet reduction ratio setting input unit) 704.

The preview image 700 represents a preview after printing by using page imposition reflecting the print setting, a line indicating the position of duplex binding, and the like, in accordance with image data of the intermediate data and the print setting.

The print setting UI 702 displays a list of a plurality of print settings (items as combinations of a plurality of print settings) to allow the user to select a print setting. For example, the print setting UI 702 displays a plurality of print settings designated by the administrator in a selectable manner so that a combination of print settings with a sheet reduction ratio equal to or greater than the sheet reduction ratio designated by the administrator can be applied to printing by single operation.

The sheet reduction ratio setting UI 704 includes a first area (displayed as an eco index in FIG. 23) for displaying a sheet reduction ratio expected to be achieved by the currently-set print setting, and a second area (an area of the eco index in FIG. 23) for displaying, with half brightness for example, a target value of a sheet reduction ratio desired by the administrator. If the target value of the sheet reduction ratio desired by the administrator is not specified in the client terminal 20, the second area serves as an input area (the area of the eco index in FIG. 23) for receiving a target value of a sheet reduction ratio desired by the user. When the target value of the sheet reduction ratio desired by the user is input in the input area of the sheet reduction ratio setting UI 704, the acquiring unit 430 acquires the target value of the sheet reduction ratio as the target value of the achievement objective.

When the acquiring unit 430 acquires the target value, the display control unit 433 displays only print settings (items as combinations of print settings), each of which meets the target value (each of which has the input sheet reduction ratio or greater), on the print setting UI 702.

The client terminal 20 stores the print setting and the achievement objective, such as the sheet reduction ratio, in the storage device in the form of the correspondence table (correspondence information), for example. FIG. 24 is a table illustrating an example of the correspondence table (correspondence information). As illustrated in FIG. 24, the correspondence table contains, for example, a name of a print setting, an icon (image), a comment, a print setting, and a sheet reduction ratio in an associated manner, and is distributed by, for example, the administrator.

The print setting defines a print setting item, such as Print Ticket, and a setting value of the print setting item in the XML format. However, descriptions, definitions, setting contents of the print setting are not limited to those as described above.

Next, a method of calculating a sheet reduction ratio as a specific example of the achievement objective will be described. A sheet reduction ratio for a currently-set print setting is calculated by using the currently-set print setting and the number of pages to be printed.

For example, the sheet reduction ratio contained in the correspondence table is a value indicating how many sheets are reduced when a print setting for reducing the number of pages to be printed is performed, relative to the number of sheets to be output when the print setting for reducing the number of pages to be printed is not performed.

However, in this method, the sheet reduction ratio contained in the correspondence table and the sheet reduction ratio obtained after actual printing may not match each other. For example, when a sheet reduction ratio of a print setting for duplex printing is set to 50% in the correspondence table, and if a document of four pages is printed by duplex printing, the number of sheets is two, resulting in the sheet reduction ratio of just 50%. However, the number of sheets is also two even when a document of three pages is printed by duplex printing. Namely, when the document of three pages is printed by duplex printing, the sheet reduction ratio becomes 33.3%.

Further, if a document size of the first page differs from that of the second page, one-side printing may be performed on two sheets even when duplex printing is set in the image forming apparatus. In this case, a result differs from the sheet reduction ratio defined in advance in the correspondence table. Therefore, the client terminal 20 may be configured to calculate a sheet reduction ratio by using the number of pages of print data, a sheet size, and orientation of a sheet, rather than using the sheet reduction ratio contained in the correspondence table.

As the print setting for reducing the number of pages to be printed, the print settings for combined printing and duplex printing are described by way of example; however, it is not limited thereto. For example, the print setting may be a setting for reducing output sheets by a blank sheet suppression setting, weekly magazine printing, or the like. Further, the image forming system 10 may be configured to improve contribution to the environment by allowing switching of the recording media, such as sheets, to recycled papers.

Furthermore, in the embodiment, the sheet reduction ratio is described as an example of the achievement objective to contribute to at least one of the environment and reduction in the total cost of ownership; however, it is not limited thereto. For example, the image forming system 10 may determine the achievement objective by using a sheet usage rate due to reduction in a sheet size, a toner usage rate, or a combination of these rates. Moreover, the achievement objective may be the amount of electricity or the amount of CO₂ emission to be reduced by changing a print condition. For example, it may be possible to calculate the amounts of reduction in electricity and CO₂ emission corresponding to a target value and include the amounts of reduction in the correspondence table in advance, and, if the achievement estimated value is 50%, the client terminal 20 may display information indicating that the amount of reduction in electricity is expected to be 50% based on the correspondence table. Furthermore, the client terminal 20 may display the amount of reduction in electricity and the amount of reduction in CO₂ emission separately or in combination. Consequently, the user can specifically check the amount of reduction in electricity and the amount of reduction in CO₂ emission, so that the effect of reduction becomes clear and the possibility to select a print output with the target value may be increased.

Next, the print dialog 70 to be displayed when the client terminal 20 sets the print setting that meets a target value of an achievement objective desired by the administrator will be described. FIG. 25 is a diagram illustrating the print dialog 70 displayed when the client terminal 20 sets a print setting that meets a target value of an achievement objective desired by the administrator.

In the example illustrated in FIG. 25, the administrator specifies the sheet reduction ratio of 70%. In this case, the print setting UI 702 displays only print settings, in each of which a sheet reduction ratio of 70% or greater is expected, in a selectable manner.

As described above, the image forming system 10 causes the information processing apparatus to transmit a target value of an achievement objective to contribute to at least one of the environment and reduction in total cost of ownership, acquires the target value from the information processing apparatus, and extracts print settings, in each of which the achievement estimated value meets the target value, based on the correspondence information indicating a correspondence relation between a plurality of different print settings and the achievement expected values expected to be obtained when the respective print settings are applied to printing. Therefore, it becomes possible for the administrator to perform print setting, which meets the target value of the achievement objective desired by the administrator, on the client terminal 20 of the user via the network.

Further, the image forming system 10 may be configured to distribute, to the client terminal 20, any of, for example, only a target value of an achievement objective, a print setting that meets the target value, or an application containing the print setting that meets the target value. Furthermore, the image forming system 10 enables the administrator to distribute a print setting to be installed or set in a device such as the client terminal 20, a computer program containing the print setting, or the like, and thereafter manage whether the client terminal 20 completes the print setting.

Each of the client terminal 20, the administrator PC 50, and the software management PC 12 of the embodiment includes a control device, such as a CPU, a storage device, such as a read only memory (ROM) or a random access memory (RAM), an external storage device, such as a hard disk drive (HDD) or a compact disk (CD) drive device, a display device, such as the above described display device, and an input device, such as a keyboard or a mouse, and has a hardware configuration using a normal computer. An image forming program executed by the client terminal 20, the administrator PC 50, and the software management PC 12 of the embodiment is provided by being recorded in a computer-readable storage medium, such as a CD-ROM, a flexible disk (FD), a CD-R, or a digital versatile disk (DVD), in a computer-installable or computer-executable file format.

Further, the image forming program executed by the client terminal 20, the administrator PC 50, and the software management PC 12 of the embodiment may be stored in a computer connected to a network, such as the Internet, and provided by being downloaded via the network. Furthermore, the image forming program executed by the client terminal 20, the administrator PC 50, and the software management PC 12 of the embodiment may be provided or distributed via a network, such as the Internet. Moreover, the image forming program of the embodiment may be provided by being incorporated in a ROM or the like in advance.

According to an embodiment of the present invention, it is possible for an administrator to perform print setting on a client terminal of a user via a network so as to meet a target value of an achievement objective, which is to contribute to at least one of the environment and reduction in the total cost of ownership, as desired by the administrator.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. A network system comprising:
an information processing apparatus that transmits a target value of an achievement objective to contribute to at least one of environment and reduction in total cost of ownership;
an acquiring unit that acquires the target value from the information processing apparatus via a network;
a storage unit that stores therein correspondence information indicating a correspondence relation between a plurality of different print settings and achievement expected values of the achievement objective expected when the respective print settings are applied to printing;
an extracting unit that extracts one or more print settings, in each of which the achievement expected value meets the target value, based on the correspondence information; and
a display unit that displays setting information indicating the one or more print settings extracted by the extracting unit.

2. The network system according to claim 1, further comprising:
an input unit that receives an input of selection of any of the one or more print settings indicated by the setting information displayed by the display unit; and
a printing unit that performs printing based on any of the one or more print settings extracted by the extracting unit in response to the input received by the input unit.

3. The network system according to claim 1, wherein the correspondence information indicates the correspondence relation by a table stored in the storage unit.

4. The network system according to claim 1, wherein the achievement objective is an objective to reduce at least one of recording media used for printing, toner, electricity, and an amount of CO₂ emission due to printing.

5. An information processing apparatus comprising:
an acquiring unit that acquires a target value of an achievement objective to contribute to at least one of environment and reduction in total cost of ownership from a different information processing apparatus via a network;
a storage unit that stores therein correspondence information indicating a correspondence relation between a plurality of different print settings and achievement expected values of the achievement objective expected when the respective print settings are applied to printing;
an extracting unit that extracts one or more print settings, in each of which the achievement expected value meets the target value, based on the correspondence information; and
a display unit that displays setting information indicating the one or more print settings extracted by the extracting unit.

6. A print setting method comprising:
acquiring a target value of an achievement objective to contribute to at least one of environment and reduction in total cost of ownership from an information processing apparatus via a network;
extracting one or more print settings, in each of which the achievement estimated value meets the target value, based on correspondence information indicating a correspondence relation between a plurality of different print settings and achievement expected values of the achievement objective expected when the respective print settings are applied to printing; and
displaying setting information indicating the one or more print settings extracted at the extracting.

7. The method according to claim 6, further comprising:
receiving an input of selection of any of the one or more print settings indicated by the setting information displayed at the displaying; and
performing printing based on any of the one or more print settings extracted at the extracting in response to the input received at the receiving.

8. The method according to claim 6, wherein the correspondence information indicates the correspondence relation by a table.

9. The method according to claim 6, wherein the achievement objective is an objective to reduce at least one of recording media used for printing, toner, electricity, and an amount of CO₂ emission due to printing.
